(19) United States
(12) Patent Application Publication
(10) Pub. No.: US 2025/0283595 A1
(43) Pub. Date: Sep. 11, 2025

(54) POLYGENERATION SCHEME WITH ZERO CARBON EMISSION

(71) Applicant: SAUDI ARABIAN OIL COMPANY, Dhahran (SA)

(72) Inventors: Ali H. AL-NASHMI, Dhahran (SA); Mustafa A. AL-JUBRAN, Dhahran (SA); Abdulaziz M. MUBARAK, Dhahran (SA)

(73) Assignee: SAUDI ARABIAN OIL COMPANY, Dhahran (SA)

(21) Appl. No.: 18/598,220

(22) Filed: Mar. 7, 2024

(51) Int. Cl. F23C 9/00; B01D 53/00; C01B 21/02; C01B 32/50; C25B 1/04; C25B 15/08; E21B 41/00; F23L 7/00

(52) U.S. Cl. CPC F23C 9/00; B01D 53/002; C01B 21/02; C01B 32/50; C25B 1/04; C25B 15/081; E21B 41/0064; F23L 7/007; B01D 2256/10; B01D 2257/504; F23C 2900/9901

(57) ABSTRACT

A circular economy polygeneration system includes an electrolyzer operable to provide hydrogen and oxygen based on water. The system includes a hydrogen firing furnace operable to burn hydrogen and produce a first flue gas including water and nitrogen. The system also includes an oxy-firing furnace operable to burn hydrocarbon fuel with oxygen provided by the electrolyzer to produce a second flue gas comprising water and carbon dioxide. Moreover, the system includes a first condenser configured to produce nitrogen and a first stream of water based on the first flue gas. The system further includes a second condenser configured to produce carbon dioxide and a second stream of water based on the second flue gas. The first and second stream of water are used by the electrolyzer to provide the hydrogen and oxygen. Additionally, the system includes a carbon capture system operable to capture carbon dioxide produced by the second condenser.

### FIELD OF THE DISCLOSURE

The present disclosure relates generally to polygeneration and, more particularly, to polygeneration with zero carbon emission.

### BACKGROUND OF THE DISCLOSURE

Polygeneration is a process used to create electricity, heat, and other by-products from one or more fuel sources. Implementation of a polygeneration system can be increasingly complex with more fuel sources that require integration of various processes or chemical reactions. A common polygeneration process is co-generation, whereby electricity and heat are produced by combustion. For example, heat generated in electric generation can be used for heating buildings or industrial processes. By employing combustion on fuel sources such as coal, natural gas, or biomass to create multiple forms of energy or materials, a polygeneration process can reduce the carbon footprint and increase sustainability of an industrial plant.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a circular economy polygeneration system includes an electrolyzer operable to provide hydrogen and oxygen based on water. The system further includes a hydrogen firing furnace operable to burn hydrogen provided by the electrolyzer and produce a first flue gas including water and nitrogen. The system also includes an oxy-firing furnace operable to burn a hydrocarbon fuel with oxygen provided by the electrolyzer to produce a second flue gas comprising water and carbon dioxide. Moreover, the system includes a first condenser configured to produce nitrogen and a first stream of water based on the first flue gas. The system further includes a second condenser configured to produce carbon dioxide and a second stream of water based on the second flue gas. The first and second stream of water are used by the electrolyzer to provide the hydrogen and oxygen. Additionally, the system includes a carbon capture system operable to capture carbon dioxide produced by the second condenser.

According to another embodiment consistent with the present disclosure, a circular economy polygeneration system with zero carbon emission that includes an electrolyzer operable to produce hydrogen and a first stream of oxygen based on water. The system further includes an air separation unit operable to produce a second stream of oxygen and a first stream of nitrogen. Further, the system includes a hydrogen firing furnace operable to burn hydrogen produced by the electrolyzer, the hydrogen firing furnace to produce a first flue gas including water and nitrogen. Further still, the system includes an oxy-firing furnace operable to burn hydrocarbon fuel with the first and second streams of oxygen, the oxy-firing furnace producing a second flue gas comprising water and carbon dioxide. The system also includes a first condenser configured to produce a second stream of nitrogen and a first stream of water based on the first flue gas. Furthermore, the system includes a second condenser configured to produce carbon dioxide and a second stream of water based on the second flue gas, such that the first and second stream of water are provided to the electrolyzer. Additionally, the system includes a carbon capture, utilization and sequestration (CCUS) unit operable to capture the carbon dioxide produced by the second condenser. Moreover, the system includes a liquefier operable to receive the first and second stream of nitrogen and provides liquid nitrogen to the first and second condensers.

According to yet another embodiment consistent with the present disclosure, a method for performing circular economy polygeneration includes separating water from an input water stream into a stream of hydrogen and a first stream of oxygen. Further, the method includes separating air from Earth's atmosphere into a second stream of oxygen and a first stream of nitrogen. Further still, the method includes combusting hydrogen produced by the electrolyzer to produce a first flue gas comprising nitrogen and water. Furthermore, the method includes combusting hydrocarbon fuel using the first and second oxygen streams to produce a second flue gas comprising water and carbon dioxide. Moreover, the method includes condensing the first flue gas to produce a first water stream and a second stream of nitrogen. The method also includes condensing the second flue gas to produce a second water stream and a stream of carbon dioxide, wherein the first and second water streams are provided to the electrolyzer. Additionally, the method includes liquefying the first and second streams of nitrogen to produce liquid nitrogen, such that the liquid nitrogen is provided to the first and second condensers as a coolant. The method further includes capturing the stream of carbon dioxide

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example block diagram of a polygeneration system for producing energy.

FIG. 2 is an example schematic diagram of a polygeneration system performing combustion.

FIG. 3 is another example schematic diagram of a polygeneration system for performing combustion with nitrogen utilization.

FIG. 4 is an example flowchart of a main method for polygeneration.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to polygeneration with zero carbon emission. In some examples, polygeneration, as disclosed herein, can be used as part of a circular economy. A circular economy refers to a process that involves recycling byproducts of a process, such as polygeneration, to reduce waste and improve efficiency. That is, products or materials produced by a process can be reused by the process, recycled, leased, or repaired to increase availability of the products or materials.

In some examples, a system for performing polygeneration can include an electrolyzer for performing electrolysis. The electrolyzer can receive water (e.g., H₂O) as an input reactant or feedstock to generate products of hydrogen (H₂) and oxygen (O₂) in response to the electrolyzer providing electrical energy to the water. Additionally, the system can include an air separation unit (ASU) that receives air as input and produces outputs of oxygen and nitrogen (N₂). The hydrogen produced by the electrolyzer can be sent to a hydrogen firing furnace, whereas the oxygen produced by the electrolyzer and ASU can be provided to an oxy-firing furnace. Each of the furnaces can produce respective flue gases that are provided to respective condensers. A condenser that receives flue gas from the oxy-firing furnace can condense the water from the respective flue gas to provide carbon dioxide to a carbon capture utilization and sequestration unit (CCUS). In some examples, the condenser associated with the hydrogen firing furnace can provide nitrogen to the atmosphere.

Additionally, each condenser can further produce and provide water that is fed back to the electrolyzer. Furthermore, nitrogen that is produced by the ASU can be liquefied by a liquefaction unit and provided to the condensers as a coolant. In some examples, nitrogen produced by the condenser associated with the hydrogen firing furnace can also be provided to the liquefaction unit to produce liquid nitrogen as coolant for the condensers.

Accordingly, each of each component of the system can be fed to another component of the polygeneration system. Therefore, the polygeneration system implements a circular economy that reduces waste compared to existing systems that release byproducts as waste by utilizing process byproducts, thereby achieving zero carbon emissions. Additionally, burning pure oxygen rather than air by the oxy-firing furnace reduces the amount of equipment needed to clean combustion products to capture carbon dioxide produced by the oxy-firing furnace compared to chemicals and scrubbing of existing systems. Furthermore, the overall carbon footprint of the polygeneration system can be reduced by supplying electrical power to the electrolyzer and ASU from renewable energy sources, rather than carbon based energy sources.

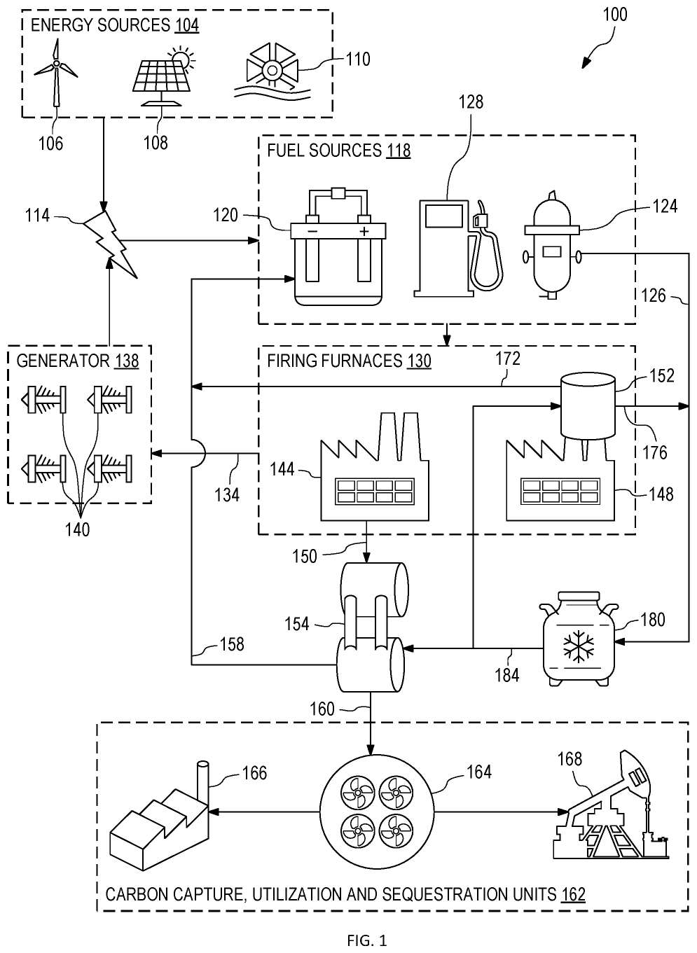

FIG. 1 illustrates an example block diagram of a polygeneration system 100 for producing energy. Energy can be produced by, for example, energy sources 104. The energy sources 104 can be “green” or renewable energy sources 104 such as a wind turbine 106, a solar photovoltaic array 108, or a water turbine 110. That is, the energy sources 104 can produce electricity 114 in a manner that does not produce carbon emissions. The electricity 114 can be provided to fuel sources 118. The fuel sources 118 can include an electrolyzer 120 and an air separation unit (ASU) 124 that use electricity to generate fuel or reactants. For example, the electrolyzer 120 can produce hydrogen and oxygen by applying electricity to water. Further, the ASU 124 can compress, cool, and distill atmospheric air to produce gaseous oxygen and a first nitrogen stream 126. Thus, the electrolyzer 120 and ASU 124 can be employed to generate gaseous hydrogen, oxygen, and nitrogen as reactants. Additionally, fuel sources 118 can include other sources, such as hydrocarbon 128. In some examples, hydrocarbon 128 is a reactant that does not require electricity 114. In other examples, electricity 114 is used to extract hydrocarbon 128 from a well or hydrocarbon 128 source.

The fuel sources 118 can provide reactants to firing furnaces 130 that perform combustion. Combustion by firing furnaces 130 can be employed to produce heat and/or electricity. For example, combustion by firing furnaces 130 produces a heat stream 134 that can be provided to a generator 138, which can be an electric generation plant. That is, the generator 138 can include one or more steam turbines 140. In response to receiving the heat stream 134, water can be converted to steam that drives the steam turbines 140 of the generator 138, such that energy is produced. The energy produced by the generator 138 can be electricity 114 that is provided to the fuel sources 118 or a grid. In an example, the firing furnaces 130 include an oxy-firing furnace 144 and a hydrogen firing furnace 148. The oxy-firing furnace 144 can perform combustion with oxygen provided by the electrolyzer 120 and ASU 124 to burn the hydrocarbon 128. Moreover, the oxy-firing furnace 144 can receive and burn pure oxygen from the fuel sources 118 instead of air, such that the oxy-firing furnace 144 does not produce nitric oxide emissions compared to existing systems. Rather, the oxy-firing furnace 144 produces a combustion product 150 (e.g., flue gas) that includes gaseous carbon dioxide and water vapor.

Each of the firing furnaces 130 can correspond to a respective condenser that receives a product from the respective firing furnace 130. For example, the hydrogen firing furnace 148 can correspond to a first condenser 152 and the oxy-firing furnace 144 can correspond to a second condenser 154. Thus, the combustion product 150 produced by the oxy-firing furnace 144 can be provided to the second condenser 154 that performs cooling with condensing scrubbers, metallic condensers, and/or heat pumps. The second condenser 154 can condense water vapor of the combustion product 150 to water, which separates the water from the carbon dioxide of the combustion product 150 because water has a higher condensation point than carbon dioxide under the same atmospheric conditions. Accordingly, the condensed water can be provided by the second condenser 154 as a first water stream 158 back to the electrolyzer 120 of the fuel sources 118. Therefore, the water condensed by the second condenser 154 can be recycled to be used by the electrolyzer 120 rather than wasted, such that the electrolyzer 120 can generate more reactants to be fed to the firing furnaces 130 based on the first water stream 158. Further, the combustion product 150 can be mostly (e.g., greater than 50%) carbon dioxide, such that the combustion product 150 is easily condensable to separate the carbon dioxide via compression separation performed by the second condenser 154.

Carbon dioxide separated from water by the second condenser 154 can also be provided as a carbon dioxide stream 160 to a carbon capture, utilization, and sequestration (CCUS) units 162. In an example, the CCUS units 162 can include a carbon capture system 164. The carbon capture system 164 can be a direct air capture (DAC) system, such that the carbon capture system 164 can employ chemical adsorption to capture carbon dioxide that passes over materials to chemically bind the materials with the carbon dioxide. The materials employed by the carbon capture system 164 can be liquid based solvents or solid based sorbents.

Carbon capture and utilization can be a separate process from carbon capture and sequestration. For example, the CCUS units 162 can further include a chemical conversion system, for example, a chemical conversion plant 166 that can convert carbon dioxide to other chemicals or fuels, such as synthetic fuels, methanol, polymers, and plastics, carbonates, building materials, biological applications, and even carbonate beverages. In some examples, mineral carbonates made at the chemical conversion plant 166 can be stored long term to prevent carbon from being released into the atmosphere. Similarly, the CCUS units 162 can also include an injection system, for example, an injection well 168, which can be part of an oil extraction site. That is, carbon dioxide can be injected into reservoirs for storage or to enhance oil recovery. Therefore, the CCUS units 162 can utilize or store carbon dioxide produced by the oxy-firing furnace 144 and separated by the second condenser 154. Thus, the CCUS units 162 ensures that the polygeneration system 100 has zero carbon emissions. Moreover, CCUS units 162 can include additional systems and processes that allow sequestration or utilization of captured carbon. In existing systems, fired heaters can emit 400 to 500 million tons of carbon dioxide every year and about 75% of carbon emissions (e.g., 300 to 375 million tons) are produced by combustion. Therefore, the polygeneration system 100 reduces the amount of carbon emissions produced by combustion that negatively impact the climate and environment.

The hydrogen firing furnace 148 receives and burns hydrogen produced by the ASU 124 in the presence of air to produce water and nitrogen. Moreover, the energy (e.g., heat stream 134) created from hydrogen combustion generates no carbon dioxide emission, such that the hydrogen firing furnace 148 is an energy source that can help reduce carbon emissions and slow global warming. Furthermore, hydrogen is an efficient energy source as hydrogen has a higher energy density than other fuels, such as hydrocarbon 128 that is burned by the oxy-firing furnace 144. Instead of producing a combustion product 150 that includes carbon dioxide, the hydrogen firing furnace 148 produces a flue gas that includes water vapor and nitrogen in response to burning the hydrogen in the presence of air. Instead of releasing the flue gas produced by the hydrogen firing furnace 148 into the atmosphere, the flue gas can be captured by the first condenser 152. The first condenser 152 can be affixed to the stack(s) of the hydrogen firing furnace 148 or can be external to the hydrogen firing furnace 148 similar to the second condenser 154. In other examples, the second condenser 154 can be affixed to the stack(s) of the oxy-firing furnace 144.

The first condenser 152 can be similar in structure and function to the second condenser 154, such that the first condenser 152 separates gaseous nitrogen from water vapor by condensing the water. The first condenser 152 can therefore provide a second water stream 172 to the electrolyzer 120 with the first water stream 158 to recycle produced water. Moreover, first condenser 152 can provide a second nitrogen stream 176. In some examples, the first and second nitrogen streams 126,176 can be provided to the atmosphere, as gaseous nitrogen does not have an adverse effect on the environment similar to carbon dioxide. To reduce waste and improve efficiency of the polygeneration system, however, the first and second streams of nitrogen 126,176 can be provided to a liquefier 180. The liquefier 180 can convert gaseous nitrogen into liquid nitrogen 184 via compression and cooling. The liquid nitrogen 184 can be provided to the first and second condensers 152,154 as a coolant to increase efficiency of the condensers. That is, the liquid nitrogen 184 can be applied to cool gases within the condensers 152,154 to reach a condensation point of the water in the respective condensers 152,154.

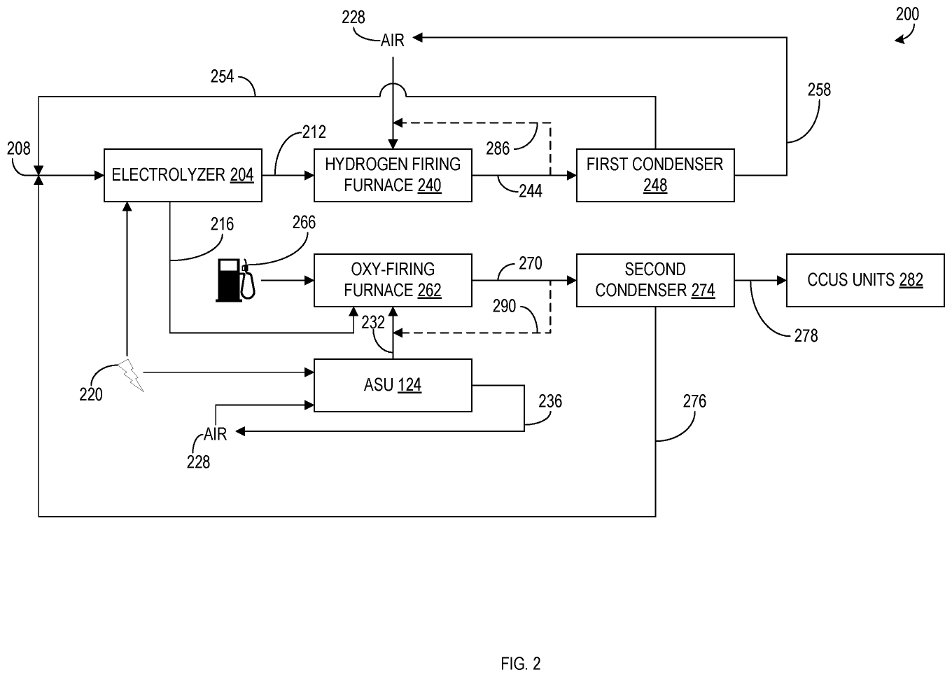

FIG. 2 illustrates an example schematic diagram of a polygeneration system 200 performing combustion. As illustrated in FIG. 2, the polygeneration system 200 can include the same or similar components as the polygeneration system 100, as illustrated in FIG. 1. Thus, reference can be made to the one or more examples of FIG. 1 in the example of FIG. 2. The polygeneration system 200 can include an electrolyzer 204 (e.g., electrolyzer 120 of FIG. 1) that performs electrolysis to separate an input water stream 208 (H₂O) into hydrogen 212 (H₂) and a first oxygen stream 216 (O₂). Further, the electrolyzer 204 can use electricity 220 (e.g., electricity 114 of FIG. 1) applied to an anode and a cathode submerged or surrounded by an electrolyte to separate the input water stream 208 into the hydrogen 212 and first oxygen stream 216. Electricity 220 can also be employed to power an air separation unit (ASU) 224 (e.g., ASU 124 of FIG. 1) that receives air 228 as an input. The air 228 can be atmospheric air and include nitrogen, oxygen, and argon, and in some instances other gases in trace amounts (e.g., less than 0.9%), such as Neon, Xenon, and Krypton. The ASU 224 can perform methods for separating one or more gases from the air 228 for example, by using membrane separation, pressure swing adsorption, and low-temperature rectification (e.g., cryogenic distillation process) based on production capacity and gas purity. Accordingly, the ASU 224 can produce a first nitrogen stream 232 (e.g., first nitrogen stream 126 of FIG. 1) and a second oxygen stream 236. Thus, the first oxygen stream 216 and hydrogen 212 produced by the electrolyzer 204, as well as the second oxygen stream 236 produced by the ASU 224, can be employed as reactants in combustion.

The system 200 can further include a hydrogen firing furnace 240 (e.g., hydrogen firing furnace 148 of FIG. 1). The hydrogen firing furnace 240 can receive the hydrogen 212 produced by the electrolyzer 204, as well as the air 228. The hydrogen firing furnace 240 can produce a first flue gas 244 that includes water and nitrogen based on the air 228 and the hydrogen 212. The hydrogen firing furnace 240 can be used to burn hydrogen gas in the presence of the air 228 to produce water and nitrogen as a by-product. The reaction can generate energy in the form of heat. The hydrogen firing furnace 240 burns hydrogen and no carbon, such that the hydrogen firing furnace 240 creates no carbon dioxide emission. The following expression (1) can define a combustion reaction equation for the hydrogen firing furnace 140:

$${H}_{2} + AIR \to {H}_{2} O + {N}_{2} \qquad ( 1 )$$

Hydrogen as a primary fuel for fired equipment, such as the hydrogen firing furnace 240, requires minimal modifications to existing furnaces. Particularly, additional equipment is not needed to process hydrogen, as hydrogen is a non-toxic substance that is not destructive or harmful to the environment or humans in contrast to traditional fossil fuels. Moreover, hydrogen is a more efficient energy source than traditional fossil fuels because hydrogen has a higher energy density than fossil fuels.

In response to producing the first flue gas 244, the hydrogen firing furnace 240 can provide the first flue gas 244 to a first condenser 248 (e.g., first condenser 152 of FIG. 1). The first condenser 248 performs flue gas condensation, such that the first flue gas 244 is cooled below its water dew point to condense and extract the water from gaseous nitrogen. Cooling by the first condenser 248 can be performed by condensing scrubbers, metallic condensers, and/or heat pumps. The first condenser 248 can produce a first feedback water stream 254 (e.g., second water stream 172 of FIG. 1) based on the extracted water from the first flue gas 244 that can be fed back to the electrolyzer 204 for processing. Thus, the extracted water can be reused by the electrolyzer 204 to extract hydrogen and oxygen in a manner similar to, or in combination with, the input water stream 208. Accordingly, by-products from the first condenser 248, such as water, are recycled to produce combustion reactants rather than being released into the environment or wasted by existing systems. That is, water of the system 200 is recycled to conserve water and reduce capital expenditures associated with procuring additional water for the system 200. The first condenser 248 can also produce a second nitrogen stream 258 (e.g., second nitrogen stream 176) that can be fed back into the air 228.

The system 200 further includes an oxy-firing furnace 262 (e.g., oxy-firing furnace 144 of FIG. 1) that can receive the first oxygen stream 216 from the electrolyzer 204 and the second oxygen stream 232 from the ASU 224. Additionally, the oxy-firing furnace 248 can be provide a hydrocarbon (HC) 266 (e.g., the hydrocarbon 128 of FIG. 1), which can be a sales gas or a mixture of hydrogen and hydrocarbon gases. The oxy-firing furnace 262 can perform combustion by burning the HC 266 using pure oxygen from the first and second oxygen streams 232,236 to produce a second flue gas 270 (e.g., carbon dioxide stream 160 of FIG. 1) that includes carbon dioxide (CO₂) and water. The following expression (2) can define the combustion reaction equation for the oxy-firing furnace:

$${C}_{x} {H}_{y} + ( x + \frac{y}{4} ) {O}_{2} \to \frac{y}{2} {H}_{2} O + {x CO}_{2} \qquad ( 2 )$$

The oxy-firing furnace 262 produces the second flue gas 270 (e.g., the carbon dioxide (CO₂) and water) that is free of nitrogen oxide emissions as in existing systems implementing circular economy. This is because nitrogen is absent from the oxy-firing combustion at the oxy-firing furnace 262. Because the oxy-firing furnace 262 does not receive nitrogen this enhances furnace efficiency of the oxy-firing furnace 262 by reducing fuel consumption by about 20%, as well as a mass and volume of the second flue gas 270 produced by the oxy-firing furnace 262 by about 75% compared to existing systems. Instead, existing systems burn air that is mostly nitrogen (e.g., 78% nitrogen), such that existing systems produce nitric oxides that contribute to smog, acid rain, and are toxic to humans.

Moreover, because the oxy-firing furnace 262 does not receive nitrogen, the oxy-firing furnace 262 can be a smaller, reduced, or a more-compact furnace in contrast to conventional furnaces used in existing systems. Additionally, the lack of nitrogen at the oxy-firing furnace 262 eliminates chemical equipment, such as amines needed to perform the reaction, and thus reduces the effects of potential environmental hazards. Therefore, the oxy-firing furnace 262 can have greater thermal efficiency and provide less toxic flue gas 270 than existing systems that perform combustion with air 228. The oxy-firing furnace 262 can also revert to fresh air firing without interruption to plant operation, such that burning pure oxygen with the oxy-firing furnace 262 does not require significant modifications and operational change. Further, the oxy-firing furnace 262 capacity can be increased if required to relieve bottlenecks in the system 200.

The system 200 can further include a second condenser 274 (e.g., second condenser 154) that receives the second flue gas 270 from the oxy-firing furnace 262. The second condenser 274 performs flue gas condensation, such that the second flue gas 270 is cooled below its water dew point to condense and extract the water from gaseous carbon dioxide. The second condenser 274 can extract water from carbon dioxide in a manner similar to the first condenser 248 because nitrogen and carbon dioxide have higher condensation points than water. The second condenser 274 can provide a second water stream 276 to the electrolyzer 204 based on the extracted water from the second flue gas 270. Accordingly, the second water stream 276 can be utilized by the electrolyzer 204 and/or combined with the input water stream 208 and provided to the electrolyzer 204.

The second flue gas 270 can be mostly (e.g., over 50%) carbon dioxide, such that carbon dioxide separated from water by the second condenser 274 is ready for capture and sequestration. More specifically, the second flue gas 270 includes carbon dioxide and water because pure oxygen is burned by the oxy-firing furnace 262, as shown in the combustion reaction equation for the oxy-firing furnace (e.g., expression (2)). Accordingly, a carbon dioxide stream 278 (e.g., carbon dioxide stream 160 of FIG. 1 and carbon dioxide stream) is produced by the second condenser 274 and provided to a carbon capture, utilization, and sequestration (CCUS) units 282 (e.g., CCUS units 162 of FIG. 1). The CCUS unit 282 can perform carbon capture and sequestration, which is the process of capturing, transporting, and storing carbon dioxide. For example, the carbon dioxide from the carbon dioxide stream 278 can be captured and stored underground, stored in mineral carbonites, or injected into a geological formation for enhancing oil and gas recovery. Accordingly, the CCUS unit 282 can perform carbon capture and sequestration to prevent the release of carbon dioxide into the air 228 to mitigate the effects of climate change caused by increased atmospheric carbon dioxide. Thus, by configuring the system 200 with the CCUS units 282 can mitigate or prevent the release of carbon dioxide provided by the HC fuel 266 into the atmosphere.

Additionally, the system 200 implements a circular economy by reusing products of the nitrogen and carbon condenser 248,274. Particularly, the first and second water streams 254, 276 can provide together approximately (e.g., +/−5%) 50% of the total water utilized by the electrolyzer 204. Furthermore, the first and second flue gases 244,270 can be recirculated to the corresponding furnace to provide control of combustion performed by the respective furnace. For example, the hydrogen firing furnace 240 can be provided a recirculated first flue gas 286 and the oxy-firing furnace 262 can be provided a recirculated second flue gas 290. By recirculating products of the respective furnaces 240,262, conditions of combustion can be monitored and controlled such as temperature, pressure, concentration of reactants (e.g., first and second oxygen streams 216,232, HC fuel 266, hydrogen stream 212), and flow rates. Accordingly, recirculated flue gases 286,290 can enable the respective furnaces 240,262 to provide combustion products (e.g., first and second flue gases 244,270) that are uniform over time to thereby enhance efficiency and stability of the system 200. Thus, control of the furnaces 240,262 can be controlled with products of the furnaces, further leveraging by-products of the system 200.

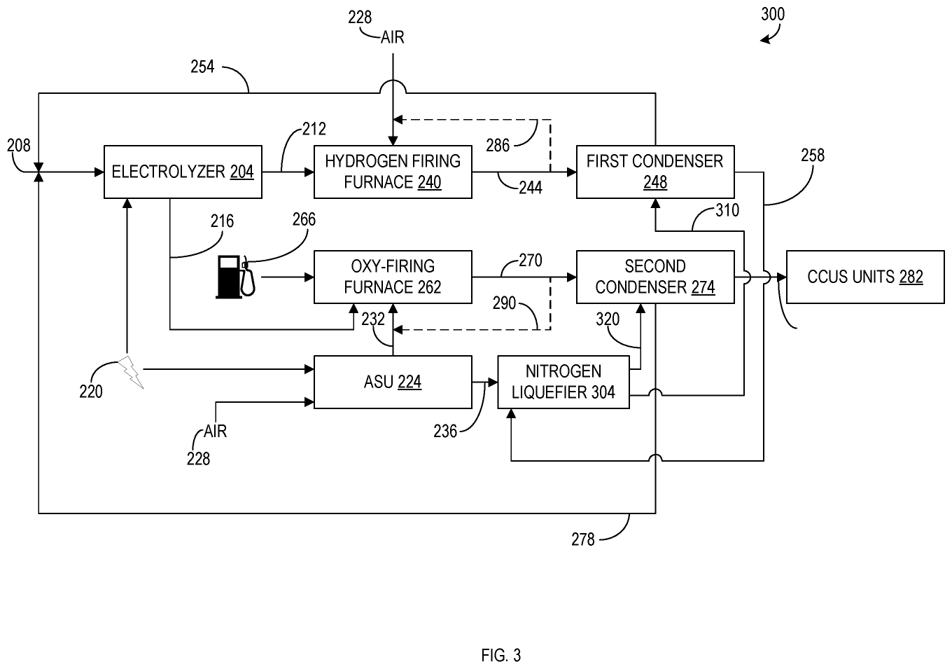

FIG. 3 illustrates another example block diagram of a polygeneration system 300 for performing combustion polygeneration with nitrogen utilization. As illustrated in FIG. 3, the polygeneration system 300 can include the same components as the systems 100,200, as illustrated in FIGS. 1-2. Thus, reference can be made to the one or more examples of FIGS. 1-2 in the example of FIG. 3. The polygeneration system 300 can perform nitrogen utilization by employing a nitrogen liquefier 304 (e.g., liquefier 180 of FIG. 1) that receives the first nitrogen stream 236 from the ASU 224. The nitrogen liquefier 204 can also receive the second nitrogen stream 258 from the first condenser 248. That is, instead of providing the first and second streams of nitrogen 236,258 to the air 228, the nitrogen produced by the ASU 224 and first condenser 248 can be captured and processed by the nitrogen liquefier 304. The nitrogen liquefier 304 can perform a liquefaction and compression process to convert received gaseous nitrogen to liquid nitrogen.

The nitrogen liquefier 304 can produce a first liquid nitrogen stream 310 that can be provided to the first condenser 248. The nitrogen liquefier 304 can further provide a second nitrogen stream 320 to the second condenser 274. The first and second streams of liquid nitrogen 210,220 (e.g., liquid nitrogen 184 of FIG. 1) can be employed by the respective nitrogen and carbon condensers 148,174 as cooling agents. For example, liquid nitrogen can be employed by a condenser or a heat exchanger of the condenser to condensate water from the respective flue gas. Accordingly, liquid nitrogen produced by nitrogen liquefier 304 can be utilized by the polygeneration system 300 to condense the first and second flue gases 244,270. Therefore, each product of each component of the polygeneration system 300 can be reused by another component of the polygeneration system 300 to improve efficiency and decrease waste compared to existing systems.

In addition to eliminating carbon emissions by the systems 100,200,300 by implementation of a circular economy, the overall carbon footprint of the systems 100,200,300 can be further reduced. For example, electricity 114,220 can be provided to existing systems from plants that burn fossil fuels, such that carbon emissions are inherently produced to provide electricity to existing systems. Accordingly, the overall carbon footprint of the systems 100,200,300 can be reduced by receiving electricity 114,220 from renewable energy sources (e.g., energy sources 104 of FIG. 1), such as wind powered generators, solar photovoltaic cells, or water powered generators. Thus, the overall carbon footprint of the systems 100,200,300 can be reduced to zero in addition to zero carbon emissions.

Furthermore, the CCUS units 162,282 can perform carbon capture and utilization, which is the process of capturing carbon dioxide to be recycled for future utilization. Carbon utilization can differ from sequestration, as utilization converts the carbon dioxide into more valuable substances or products while retaining the carbon neutrality of the production processes, whereas carbon sequestration removes available carbon from the atmosphere. For example, the CCUS units 162,282 can convert captured carbon dioxide into synthetic fuels, chemicals, or building materials. Accordingly, the CCUS units 162,282 can be employed to store carbon dioxide for oil and gas recovery (e.g., sequestration), as well as generate commercial products from carbon dioxide (e.g., utilization).

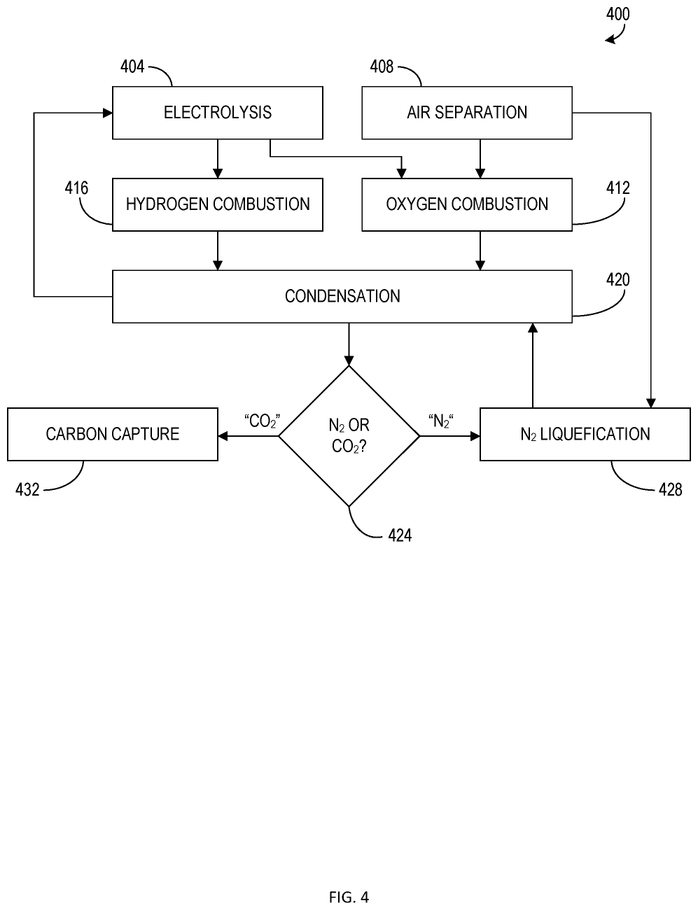

In view of the structural and functional features described above, an example method will be better appreciated with reference to FIGS. 1-3. While, for purposes of simplicity of explanation, the example method of FIG. 4 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 4 is a flowchart example of a method 300 for circular economy polygeneration. The method 300 can be implemented by polygeneration systems 100,200,300 as shown in FIGS. 1-3. Thus, reference can be made to the examples of FIGS. 1-3. The method 400 can begin at 404 by performing electrolysis on a water stream by an electrolyzer (e.g., electrolyzer 120 of FIG. 1 and electrolyzer 204 of FIGS. 2-3). Electrolysis produces hydrogen and oxygen via an electrical reaction on water received by an electrolyzer. At 408, air can be separated by an air separation unit (ASU) (e.g., ASU 124 of FIG. 1 and ASU 224 of FIGS. 2-3), such that the ASU produces oxygen and nitrogen (e.g., first nitrogen stream 126 of FIG. 1 and first nitrogen stream 236 of FIGS. 2-3). At 412, oxygen combustion is performed by an oxy-firing furnace (e.g., oxy-firing furnace 144 of FIG. 1 and oxy-firing furnace 262 of FIGS. 2-3) that uses oxygen provided by the ASU and electrolyzer to burn hydrocarbon fuel (e.g., HC fuel 128 of FIG. 1 and HC fuel 266 of FIGS. 2-3).

At 416, hydrogen combustion is performed by a hydrogen firing furnace (e.g., hydrogen firing furnace 148 of FIG. 1 and hydrogen firing furnace 240 of FIGS. 2-3). Hydrogen combustion is performed by burning hydrogen to produce energy as heat (e.g., heat stream 134 of FIG. 1). Because hydrogen and air are used by the hydrogen firing furnace, the hydrogen firing furnace produces nitrogen and water as by-products. More particularly, hydrogen combustion at 416 and oxygen combustion at 412 produce respective flue gases (e.g., first and second flue gases 244,270 of FIGS. 2-3) that include the nitrogen, carbon dioxide and water as byproducts. Accordingly, condensation can be performed on the flue gases at 420 by a condenser. In some examples, flue gas produced during hydrogen combustion 416 can be provided to a condenser (e.g., first condenser 152 of FIG. 1 and first condenser 248 of FIGS. 2-3) separate from a condenser for the flue gas produced during oxygen combustion (e.g., second condenser 154 of FIG. 1 and second condenser 274 of FIGS. 2-3). In each example, a condenser can be employed to separate water from other byproducts of the flue gas.

Furthermore, water produced by condensation can be fed back to the electrolysis at 304 to further separate the water into hydrogen and oxygen. Therefore, the hydrogen and oxygen can again be used for hydrogen and oxygen combustion at steps 412 and 416. Accordingly, water produced from condensation at 420 can be continuously reused, such that steps 404 and 412-420 repeat as long as water is condensed at 420. At 424, it can be determined whether the byproduct of condensation at 420 is nitrogen (e.g., second nitrogen stream 258 of FIG. 2-3) or carbon dioxide (e.g., carbon dioxide stream). The byproduct can be dependent on which flue gas was condensed. If it is determined at 324 that N₂ is produced via condensation at 420 (e.g., N₂), the nitrogen can be liquefied at 428 by a nitrogen liquefier (e.g., nitrogen liquefier 204 of FIG. 2).

At 428, liquefaction can be performed on nitrogen produced by the ASU at 408 and the nitrogen produced by condensation at 420. That is, gaseous nitrogen can be liquefied to produce liquid nitrogen at 428 that can be further employed as a coolant. Therefore, the liquid nitrogen produced at 428 can be fed back to condensers that perform condensation at 420. If it is determined at 424 that CO2 is produced via condensation at 420 (e.g., “CO₂”), the CO₂ can be captured at 432 by a carbon capture, utilization and sequestration unit (CCUS) (e.g., CCUS 182 of FIGS. 1-2). Accordingly, the method 400 implements circular economy polygeneration that utilizes each byproduct produced during implementation of the method 400. Moreover, the method 300 eliminates carbon emissions that are produced by existing methods of energy generation.

Embodiments disclosed herein include:

A. A circular economy polygeneration system comprising an electrolyzer operable to provide hydrogen and oxygen based on water; a hydrogen firing furnace operable to burn hydrogen provided by the electrolyzer and produce a first flue gas comprising water and nitrogen; an oxy-firing furnace operable to burn a hydrocarbon fuel with oxygen provided by the electrolyzer to produce a second flue gas comprising water and carbon dioxide; a first condenser configured to produce nitrogen and a first stream of water based on the first flue gas; a second condenser configured to produce carbon dioxide and a second stream of water based on the second flue gas, wherein the first and second stream of water are used by the electrolyzer to provide the hydrogen and oxygen; and a carbon capture system operable to capture carbon dioxide produced by the second condenser.

B. A circular economy polygeneration system with zero carbon emission comprising an electrolyzer operable to produce hydrogen and a first stream of oxygen based on water; an air separation unit operable to produce a second stream of oxygen and a first stream of nitrogen; a hydrogen firing furnace operable to burn hydrogen produced by the electrolyzer, the hydrogen firing furnace to produce a first flue gas comprising water and nitrogen; an oxy-firing furnace operable to burn hydrocarbon fuel with the first and second streams of oxygen, the oxy-firing furnace producing a second flue gas comprising water and carbon dioxide; a first condenser configured to produce a second stream of nitrogen and a first stream of water based on the first flue gas; a second condenser configured to produce carbon dioxide and a second stream of water based on the second flue gas, wherein the first and second stream of water are provided to the electrolyzer; a carbon capture, utilization and sequestration (CCUS) unit operable to capture the carbon dioxide produced by the second condenser; and a liquefier operable to receive the first and second stream of nitrogen and provides liquid nitrogen to the first and second condensers.

C. A method for performing circular economy polygeneration comprising separating water from an input water stream into a stream of hydrogen and a first stream of oxygen; separating air from Earth's atmosphere into a second stream of oxygen and a first stream of nitrogen; combusting hydrogen produced by the electrolyzer to produce a first flue gas comprising nitrogen and water; combusting hydrocarbon fuel using the first and second oxygen streams to produce a second flue gas comprising water and carbon dioxide; condensing the first flue gas to produce a first water stream and a second stream of nitrogen; condensing the second flue gas to produce a second water stream and a stream of carbon dioxide, wherein the first and second water streams are provided to the electrolyzer; liquefying the first and second streams of nitrogen to produce liquid nitrogen, wherein the liquid nitrogen is provided to the first and second condensers as a coolant; and capturing the stream of carbon dioxide.

Each of embodiments A through C may have one or more of the following additional elements in any combination: Element 1: The system further comprising an air separation unit (ASU) that provides oxygen to the oxy-firing furnace based on air, wherein the oxy-firing furnace burns pure oxygen. Element 2: wherein the ASU separates air to produce oxygen and nitrogen, wherein the nitrogen produced by the ASU is a first stream of nitrogen and the nitrogen produced by the first condenser is a second stream of nitrogen. Element 3: The system further comprising a liquefier that receives the first and second stream of nitrogen. Element 4: wherein the liquefier produces liquid nitrogen and provides liquid nitrogen to the first and second condensers as a coolant to condense water of the first and second condensers from a vapor state to a liquid state.

Element 5: wherein the hydrogen firing furnace is controlled by providing the first flue gas as an input to the hydrogen firing furnace to enhance combustion of the hydrogen firing furnace. Element 6: wherein the oxy-firing furnace is controlled by providing the second flue gas as an input to the oxy-firing furnace to enhance combustion of the oxy-firing furnace. Element 7: wherein a sequestration system performs sequestration of the carbon dioxide by injecting carbon dioxide into a geological formation. Element 8: wherein a utilization system converts captured carbon dioxide into another material.

Element 9: wherein the electrolyzer and the ASU are powered by electricity produced by renewable energy sources. Element 10: wherein approximately half of the water processed by the electrolyzer is produced by the first and second condensers. Element 11: wherein the second flue gas is mostly carbon dioxide. Element 12: wherein the second flue gas is mostly carbon dioxide and approximately half of the water processed by the electrolyzer is produced by the first and second condensers. Element 13: wherein the hydrogen firing furnace is controlled by providing the first flue gas as an input to the hydrogen firing furnace and the oxy-firing furnace is controlled by providing the second flue gas as an input to the oxy-firing furnace, thereby enhancing combustion of the respective furnaces.

Element 14: wherein the electrolyzer and the ASU are powered by electricity produced by renewable energy sources. Element 15: wherein the CCUS unit is a first CCUS unit, a second CCUS unit is operable to perform sequestration of the carbon dioxide by injecting the carbon dioxide into a geological formation, and a third CCUS unit is operable to perform utilization of the carbon dioxide by converting the captured carbon dioxide into another material. Element 16: The method further comprising utilizing the captured carbon dioxide to generate another material. Element 17: The method further comprising injecting captured carbon dioxide into a geological formation.

By way of non-limiting example, exemplary combinations applicable to A through C include: Element 1 with Element 2; Element 2 with Element 3; Element 3 with Element 4; Element 4 with Element 5; Element 5 with Element 6; Element 6 with Element 7; Element 6 with Element 8; Element 8 with Element 9; Element 9 with Element 10; Element 10 with Element 11; Element 12 with Element 13; Element 13 with Element 14; and Element 14 with Element 15.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A circular economy polygeneration system comprising:
an electrolyzer operable to provide hydrogen and oxygen based on water;
a hydrogen firing furnace operable to burn hydrogen provided by the electrolyzer and produce a first flue gas comprising water and nitrogen;
an oxy-firing furnace operable to burn a hydrocarbon fuel with oxygen provided by the electrolyzer to produce a second flue gas comprising water and carbon dioxide;
a first condenser configured to produce nitrogen and a first stream of water based on the first flue gas;
a second condenser configured to produce carbon dioxide and a second stream of water based on the second flue gas, wherein the first and second stream of water are used by the electrolyzer to provide the hydrogen and oxygen; and
a carbon capture system operable to capture carbon dioxide produced by the second condenser.

2. The system of claim 1, further comprising an air separation unit (ASU) that provides oxygen to the oxy-firing furnace based on air, wherein the oxy-firing furnace burns pure oxygen.

3. The system of claim 2, wherein the ASU separates air to produce oxygen and nitrogen, wherein the nitrogen produced by the ASU is a first stream of nitrogen and the nitrogen produced by the first condenser is a second stream of nitrogen.

4. The system of claim 3, further comprising a liquefier that receives the first and second stream of nitrogen.

5. The system of claim 4, wherein the liquefier produces liquid nitrogen and provides liquid nitrogen to the first and second condensers as a coolant to condense water of the first and second condensers from a vapor state to a liquid state.

6. The system of claim 5, wherein the hydrogen firing furnace is controlled by providing the first flue gas as an input to the hydrogen firing furnace to enhance combustion of the hydrogen firing furnace.

7. The system of claim 6, wherein the oxy-firing furnace is controlled by providing the second flue gas as an input to the oxy-firing furnace to enhance combustion of the oxy-firing furnace.

8. The system of claim 7, wherein a sequestration system performs sequestration of the carbon dioxide by injecting carbon dioxide into a geological formation.

9. The system of claim 7, wherein a utilization system converts captured carbon dioxide into another material.

10. The system of claim 9, wherein the electrolyzer and the ASU are powered by electricity produced by renewable energy sources.

11. The system of claim 10, wherein approximately half of the water processed by the electrolyzer is produced by the first and second condensers.

12. The system of claim 11, wherein the second flue gas is mostly carbon dioxide.

13. A circular economy polygeneration system with zero carbon emission comprising:
an electrolyzer operable to produce hydrogen and a first stream of oxygen based on water;
an air separation unit operable to produce a second stream of oxygen and a first stream of nitrogen;
a hydrogen firing furnace operable to burn hydrogen produced by the electrolyzer, the hydrogen firing furnace to produce a first flue gas comprising water and nitrogen;
an oxy-firing furnace operable to burn hydrocarbon fuel with the first and second streams of oxygen, the oxy-firing furnace producing a second flue gas comprising water and carbon dioxide;
a first condenser configured to produce a second stream of nitrogen and a first stream of water based on the first flue gas;
a second condenser configured to produce carbon dioxide and a second stream of water based on the second flue gas, wherein the first and second stream of water are provided to the electrolyzer;
a carbon capture, utilization and sequestration (CCUS) unit operable to capture the carbon dioxide produced by the second condenser; and
a liquefier operable to receive the first and second stream of nitrogen and provides liquid nitrogen to the first and second condensers.

14. The polygeneration system of claim 13, wherein the second flue gas is mostly carbon dioxide and approximately half of the water processed by the electrolyzer is produced by the first and second condensers.

15. The polygeneration system of claim 14, wherein the hydrogen firing furnace is controlled by providing the first flue gas as an input to the hydrogen firing furnace and the oxy-firing furnace is controlled by providing the second flue gas as an input to the oxy-firing furnace, thereby enhancing combustion of the respective furnaces.

16. The polygeneration system of claim 15, wherein the electrolyzer and the ASU are powered by electricity produced by renewable energy sources.

17. The polygeneration system of claim 16, wherein the CCUS unit is a first CCUS unit, a second CCUS unit is operable to perform sequestration of the carbon dioxide by injecting the carbon dioxide into a geological formation, and a third CCUS unit is operable to perform utilization of the carbon dioxide by converting the captured carbon dioxide into another material.

18. A method for performing circular economy polygeneration comprising:
separating water from an input water stream into a stream of hydrogen and a first stream of oxygen;
separating air from Earth's atmosphere into a second stream of oxygen and a first stream of nitrogen;
combusting hydrogen produced by the electrolyzer to produce a first flue gas comprising nitrogen and water;
combusting hydrocarbon fuel using the first and second oxygen streams to produce a second flue gas comprising water and carbon dioxide;
condensing the first flue gas to produce a first water stream and a second stream of nitrogen;
condensing the second flue gas to produce a second water stream and a stream of carbon dioxide, wherein the first and second water streams are provided to the electrolyzer;
liquefying the first and second streams of nitrogen to produce liquid nitrogen, wherein the liquid nitrogen is provided to the first and second condensers as a coolant; and
capturing the stream of carbon dioxide.

19. The method of claim 18, further comprising utilizing the captured carbon dioxide to generate another material.

20. The method of claim 18, further comprising injecting captured carbon dioxide into a geological formation.
